(19) United States
(12) Patent Application Publication
(10) Pub. No.: US 2025/0029126 A1
(43) Pub. Date: Jan. 23, 2025

(54) TOOLS FOR DATA COLLECTION

(71) Applicant: Joseph A. Fioramonti, JR., Medway, MA (US)

(72) Inventor: Joseph A. Fioramonti, JR., St. Augustine, FL (US)

(21) Appl. No.: 18/224,136

(22) Filed: Jul. 20, 2023

(51) Int. Cl. G06Q 30/0203; G06F 3/01; G06F 3/0486

(52) U.S. Cl. CPC G06Q 30/0203; G06F 3/013; G06F 3/0486

(57) ABSTRACT

Memory is provided that is configured to hold data representing a set of graphic samples. The data may be data identifying the set of graphic samples, e.g., pixel images, collections of primitives, and/or triangle primitives. The data may be in a form of one or more file types, such as a vector image file (e.g., pdf) constructed with proportional formulas. The file type may be a raster graphics file (e.g., gif or jpeg) composed of an array of pixels. A question presenter is provided that is configured to present to an audience member's device a question about the set of graphic samples. A graphic sample presenter is provided that is configured to present, on a display of the audience member's device, the set of graphic samples in final presentation mode. The samples in the final presentation may be in a two dimensional pattern. The two dimensional pattern may comprise abutting rectangular samples. The samples may be presented at different times, e.g., in succession, on the audience member's display. A graphic input is provided that is configured to receive sample indications from the audience member via the display. The received sample indications are associated with respective ones of the samples. More specifically, the sample indications may be associated with a particular subsection of a given sample. The memory holds dimensional variables and object identifiers associated with a given graphic sample. The dimensional variables include an extent to which the given graphic sample spans first and second directions.

### FIELD OF THE DISCLOSURE

Aspects of the present disclosure relate to systems and tools for communicating and interacting with an audience in order to assess the audience's reaction to one or more graphic design elements.

### BACKGROUND OF THE DISCLOSURE

A mood board is a mechanism for presenting media design samples (graphics, text, stylized text, video, audio, and other perceptible objects). Media designers, app user experience designers, and other creators may use mood boards to present samples of a design they may wish to pursue.

U.S. Pat. No. 7,707,171 (“the '171 patent”) discloses a system and method for response clustering, and discloses an embodiment involving mood board formats and an interactive visual mosaic. Referring to the '171 patent, for example, at FIG. 1A and col. 1, line 26 et seq., a consumer's buying decision, after viewing an item 18, is influenced by his logical side and emotional side. The '171 patent provides a way to try to capture the emotional side of people, and recommend a course of action to appeal to a target market. The '171 patent describes various ways data can be collected about the reactions people have to images, through use of an interactive visual mosaic. FIG. 1B of the '171 patent shows a clustering system 20 with an interactive module 22 that delivers visual images to a respondent, Respondent feedback is collected via different channels, for example, desktops, portable computers, or kiosks. The '171 patent, col. 3, line 59-col. 4, line 11.

### SUMMARY OF THE DISCLOSURE

There is a need for improved communications systems that allow designers to present an audience with design options and obtain feedback from the audience. There is also a need for new and improved tools for obtaining feedback via such communications systems.

An objective of the present disclosure is to bring designers and their audiences together, and enable audience members to provide feedback on proposed designs. One or more alternate or additional objectives may be served by the present disclosure, for example, as may be apparent by the following description. Embodiments of the disclosure include any apparatus, machine, system, method, article (e.g., computer-readable media), or any one or more subparts or sub-combinations of such apparatus (singular or plural), system, method, or article, for example, as supported by the present disclosure. Embodiments herein also contemplate that any one or more processes as described herein may be incorporated into a processing circuit.

One embodiment of the present disclosure is directed to apparatus. Memory is provided that is configured to hold data representing a set of media design samples. The data may be data identifying a set of graphic samples, e.g., pixel images, collections of primitives, and/or triangle primitives. The data may be in the form of one or more file types. A vector image file (e.g., pdf) may be provided that is constructed with proportional formulas. A raster graphics file (e.g., gif or jpeg) may be provided that is composed of an array of pixels.

A question presenter is provided that is configured to present to an audience member's device a question about the set of graphic samples. A graphic sample presenter is provided that is configured to present, on a display of the audience member's device, the set of graphic samples. The samples in the presentation may be in a two dimensional pattern. The two dimensional pattern may comprise abutting rectangular samples. The samples may be presented at different times, e.g., in succession, on the audience member's display.

A graphic input is provided that is configured to receive feedback data in the form of sample indications from the audience member via the display. The received sample indications are associated with respective ones of the samples. More specifically, the sample indications may be associated with a particular subsection of a given sample.

In select embodiments, the memory holds element identifiers associated with elements of a given graphic sample. The memory may per another embodiment hold dimensional variables that represent an extent to which the given graphic sample spans first and second directions. In another embodiment, the dimensional variables represent an extent to which a given graphic sample spans first, second, and third directions. The dimensional variables may be in terms of pixels and/or world coordinates.

An authentic entry checker may be provided in one embodiment. The authentic entry checker includes a normal range detector to detect when audience member actions are in a normal range deemed appropriate for a genuine entry. When the action is detected to be outside the normal range, it is deemed inauthentic. In one embodiment, the audience member action is eye-tracking. In another embodiment, the audience member action is a mouse click over an associated sample or sample element. For example, the member's aggregated clicks associated with a given graphic sample are determined, and if those clicks are below a threshold level of clicks per unit of time, then the action is deemed authentic. The authentic entry checker may include a DOM referencer configured to access a document object model associated with the set of graphic samples when the set of graphic samples is presented on the display of the audience member's device. in one embodiment, the document object model is accessed in order to determine user interactions that correspond to genuine sample indications.

In one embodiment, a feedback refiner is provided, that refines the sample indications by associating them with specific subsections. In another embodiment, the refinement involves associating the sample indication with one or more particular objects embedded in a given sample. The sample indication may be associated with specific portions of the given sample by referring to layout data, dimensional variables, and/or object identifiers.

In another embodiment, a bad lighting detector is provided that determines if a sample indication corresponds to a portion of a sample with bad lighting. When this occurs, the sample indication may be rejected as mistaken, or tagged as a member of a separate data category. In another embodiment, a low resolution detector is provided that determines if a sample indication corresponds to a portion of a sample with a low resolution. Similarly, when low resolution corresponds to the sample indication, the sample indication may be rejected as mistaken, or tagged as a member of a separate data category.

Per another embodiment, sample indications may be configured to include a number set, where individuals are able to associate more favorable and less favorable parameters with elements in an image or collection of images. A drag and drop mechanism may be provided to accept such input from individuals. In one embodiment, elements are ranked with an incremental indicator representing a quantity or magnitude of an indication (e.g., an integer between 1 and X, where 1 represents a least favorable indication and X represents a most favorable indication). In another embodiment, an option is provided for participants to leave comments on a given spot, to explain the chosen location and feedback data for that location.

### DESCRIPTION OF THE DRAWINGS

Example embodiments will be described with reference to the following drawings, in which:

FIG. 1 is a block diagram of one embodiment of a graphic sample assessment system;

FIG. 2 is a diagram showing example embodiment data structure types representing content portrayed through the graphic samples;

FIG. 3A is a flow diagram of a question presenter process for interacting with an audience member's device;

FIG. 3B is a flow diagram illustrating various processes and features for obtaining audience feedback;

FIG. 4 shows a block diagram of systems and processes for interfacing with and processing image files, in one or more embodiments;

FIG. 5A is a block diagram of a sequence display of a set of graphic samples;

FIG. 5B is a block diagram of a grid display of a set of graphic samples;

FIG. 6 is a block diagram showing associated data for a set of graphic samples;

FIG. 7 is a schematic representation of a composite bitmap image;

FIG. 8 is a block diagram showing hardware for buffering and displaying a composite bitmap image;

FIG. 9 is a block diagram showing hardware for buffering and displaying separate bitmap images; and

FIG. 10 is a block diagram showing hardware for processing, buffering, and displaying bitmap and vector images.

### DETAILED DESCRIPTION

In accordance with one or more embodiments herein, various terms may be defined as follows.

Program. A program includes software of a processing circuit.

Application program. An application program is a program that, when executed, involves user interaction, whereas an operating system program, when executed, serves as an interface between an application program and underlying hardware of a computer. Any one or more of the various acts described below may be carried out by a program, e.g., an application program and/or operating system program.

Processing circuit. A processing circuit may include both (at least a portion of) computer-readable media carrying functional encoded data and components of an operable computer. The operable computer is capable of executing (or is already executing) the functional encoded data, and thereby is configured when operable to cause certain acts to occur. A processing circuit may also include: a machine or part of a machine that is specially configured to carry out a process, for example, any process described herein; or a special purpose computer or a part of a special purpose computer. A processing circuit may also be in the form of a general purpose computer running a compiled, interpretable, or compilable program (or part of such a program) that is combined with hardware carrying out a process or a set of processes. A processing circuit may further be implemented in the form of an application specific integrated circuit (ASIC), part of an ASIC, or a group of ASICs. A processing circuit may further include an electronic circuit or part of an electronic circuit. A processing circuit does not exist in the form of code per se, software per se, instructions per se, mental thoughts alone, or processes that are carried out manually by a person without any involvement of a machine.

User interface tools; user interface elements; output user interface; input user interface; input/output user interface; and graphical user interface tools. User interface tools are human user interface elements which allow human user and machine interaction, whereby a machine communicates to a human (output user interface tools), a human inputs data, a command, or a signal to a machine (input user interface tools), or a machine communicates, to a human, information indicating what the human may input, and the human inputs to the machine (input/output user interface tools). Graphical user interface tools (graphical tools) include graphical input user interface tools (graphical input tools), graphical output user interface tools (graphical output tools), and/or graphical input/output user interface tools (graphical input/output tools). A graphical input tool is a portion of a graphical screen device (e.g., a display and circuitry driving the display) configured to, via an on-screen interface (e.g., with a touchscreen sensor, with keys of a keypad, a keyboard, etc., and/or with a screen pointer element controllable with a mouse, toggle, or wheel), visually communicate to a user data to be input and to visually and interactively communicate to the user the device's receipt of the input data. A graphical output tool is a portion of a device configured to, via an on-screen interface, visually communicate to a user information output by a device or application. A graphical input/output tool acts as both a graphical input tool and a graphical output tool. A graphical input and/or output tool may include, for example, screen displayed icons, buttons, forms, or fields. Each time a user interfaces with a device, program, or system in the present disclosure, the interaction may involve any version of user interface tool as described above, e.g., which may be a graphical user interface tool.

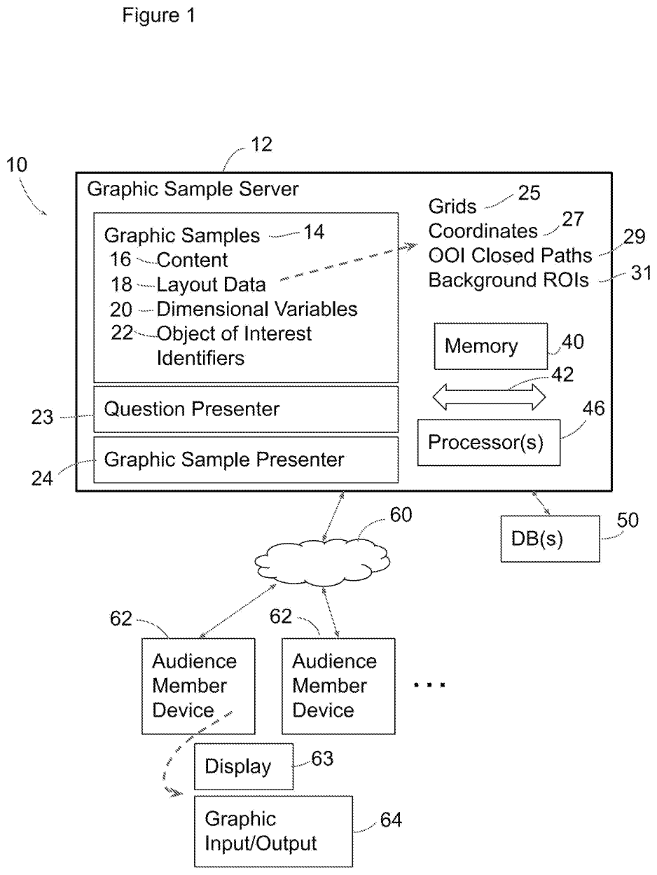

Referring now to the drawings in greater detail, FIG. 1 is a block diagram of one embodiment of a graphic sample assessment system 10. A graphic sample server 12 is provided that is coupled to a network 60, and, via network 60, to a number of audience member devices 62. In one embodiment, server 12 is hosted by the party seeking to obtain assessments of its media samples. Alternatively, server 12 may be hosted by a third party, or accessible through a cloud service. A given audience member device 62 can be a desktop, a laptop, a smartphone, a wearable device, a tablet, or another smart device, and generally has a display 63 and a graphical input/output tool 64 (as defined herein).

Server 12 comprises a memory system or hierarchy 40, a bus or connection architecture 42, and one or more processors 46. In one example embodiment, memory 40 includes RAM and secondary memory, e.g., one or more registers, one or more caches, main memory or RAM, a hard disk, and cloud storage. Server 12 includes data processes, data, and data structures collectively in the form of one or more processing circuits, stored/held by memory 40 and instantiated or run by processor(s) 46. Those data and data structures as shown in FIG. 1 include graphic samples 14 represented by content 16, layout data 18, dimensional variables 20, and object of interest (OOI) identifiers. The data processes include a question presenter 23 and a graphic sample presenter 24.

Layout data 18 represents the manner in which graphic samples are to be presented in the form of a mood board presentation, for example, in a grid. Dimensional variables 20 include an extent to which a given graphic sample spans directions in two or more dimensions. For example, in select embodiments, the graphic sample may span first and second or first, second, and third directions. Depending on the embodiment, the dimensions may be represented in pixels or in real world coordinate units.

The graphic samples are represented by data held in memory. The data identifies a set of graphic samples, for example, in the form of pixel images and/or collections of primitives such as triangle primitives. Graphic sample files may be provided including a vector image file, e.g., a pdf, constructed with proportional formulas rather than pixels. Vector graphics are generally composed of paths. Raster graphics files (also called bitmap images) may be provided, which are composed of pixels, generally an array of pixels, e.g., gif or jpeg.

Layout data 18 in select embodiments comprises data identifying and defining grids 25, coordinates 27 in relation to grids and/or image elements, object of interest (001) closed paths 29, and background regions of interest (ROIs) 31.

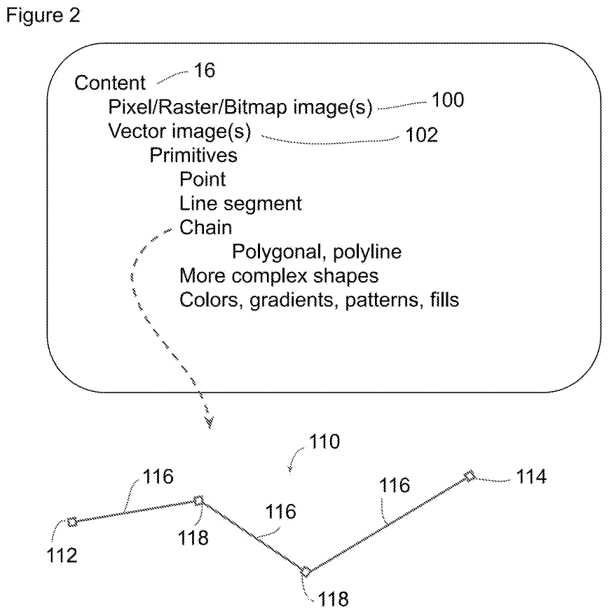

FIG. 2 is a diagram showing the data structure types representing content 16 portrayed through the graphic samples. Content 16 includes pixel images 100 and/or vector images 102. Vector images generally include shapes in terms of sets of points, in two dimensions. Alternatively, shapes and the image may be represented in three dimensions, e.g., in cartesian coordinates p=(x,y) or p=(x,y,z). The two-dimension locations on a flat display are then determined by doing a transformation on the points. Vector images are made of objects called vectors. The objects may be primitives, a point, line segment, polygonal or polyline chains, or a polygon. More complex shapes may be represented. In addition, a vector image may include other parameters such as colors, gradients, patterns, and fills. A subject may be isolated from its background, by using a clipping path or image masking.

A polyline chain 110 is shown in FIG. 2. A polyline chain may be in the form of a closed path, i.e., a closed polyline chain or polygon. The illustrated polyline chain 110 includes a start point 112 and an end point 114. A number of intermediate anchor points 118 are provided, and path segments 116 are the lines that join the adjacent anchor points, including the start and end anchor points at each end.

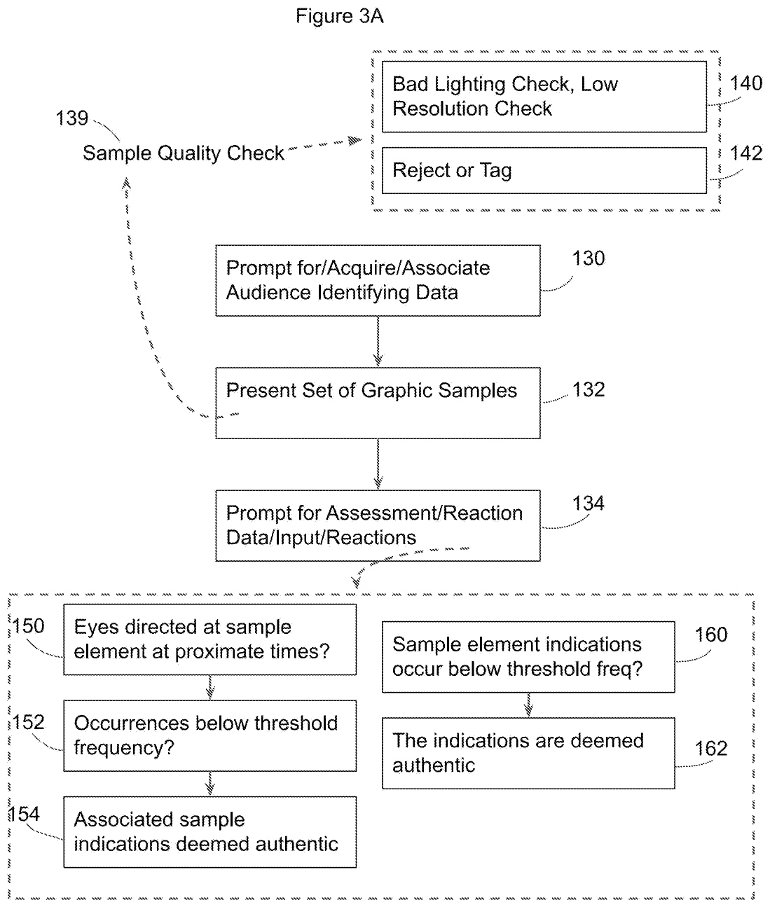

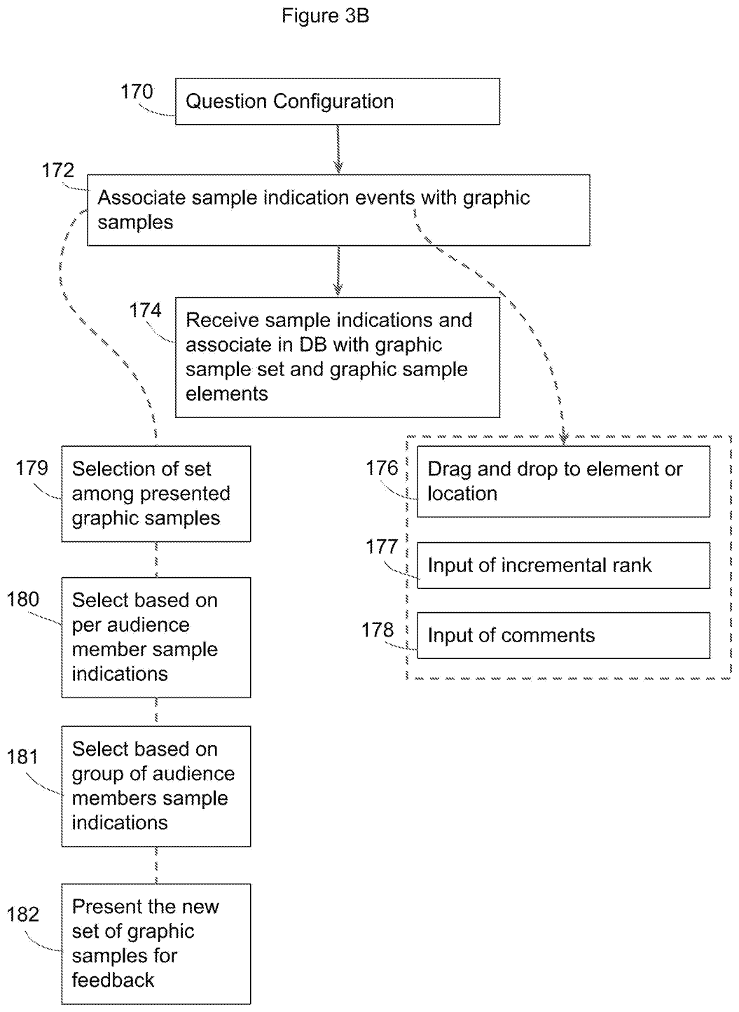

FIG. 3A is a flow diagram of a question presenter process for interacting with an audience member's device. In act 130, identifying data is obtained that uniquely represents the audience member and/or the audience member's device. This may be done by prompting, on the audience member's device's display, for login or other identification information. The identifying data may be anonymous in select embodiments. Identifying data may be obtained automatically from a number generator that generates a code and associates the code with IP, software, and/or hardware information unique to the audience member. The resulting identifying data is associated with the audience member and all activity of the audience member that is monitored and stored in one or more records in database(s) 50.

In act 132, which may follow act 130, a set of graphic samples is presented on the display of the audience member's device. In act 134, the audience member is prompted through an interaction with the audience member's device, e.g., the device's display, for input by the audience member.

As the process presents graphic samples, it may reject or tag images or image portions due to problems with the image determined in a sample quality check 139. For example, as shown at act 140, a bad lighting check and/or a low resolution (or low image quality) check may each be performed. The results of these checks may result in a given image or image portion being held back and/or tagged at act 142. Per one embodiment, an image quality check may be performed using pixel-based metrics. For example, the PSNR (peak signal to noise ratio) can be an indicator of image quality. Per another embodiment, the SSIM (structural similarity index measure) may be determined as an indicator of image quality. SSIM=10*log¹⁰ (MAX²(I)/MSE (mean square error)). MAX²(I) is the value of the maximum possible pixel value.

Poor lighting can be determined, for example, by calculating the average brightness of the original image (the mean of the pixel intensities) and compare that value to a threshold.

When assessments and audience inputs are received, an authenticity check may be performed in order to make sure that that feedback data is authentic. As shown in FIG. 3A, at act 150, an eye tracker (webcam and software in select embodiments) may be used to determine whether the eyes are directed at the sample element at proximate times which in one embodiment are times close to and leading up to a sample indication event. If the eyes are directed at the sample element at proximate times, and as determined in act 152, the eye contact is not varied too frequently meaning that occurrences of eye contact are below a threshold frequency, then in act 154, a determination is made that the associated sample indications are deemed authentic.

If sample element indications occur too frequently in a short amount of time, then that may be associated with a state of inauthenticity. When the sample element indications (e.g., mouse clicks) are below a threshold frequency as determined at act 160, at act 162 the indications are deemed authentic.

FIG. 3B shows processes for audience feedback related to graphic samples. In act 170, questions are configured in the system. Some questions could be: Which graphic samples do you like? Which graphic samples do you dislike? Which images best represent your brand, or your product, or your company? Drag and drop indications may be configured to allow responses to these and other configured questions.

In act 172, sample indication events are associated with the graphic samples, e.g., by making modifications to or interacting with a document object model. Some types of sample indication events that may be configured include drag and drop to an element or location (act 176), input of an incremental rank (act 177), or input of comments at a given element or location (act 178). In some embodiments, heat maps are employed, where increased activity is represented, in data and visually, by a greater concentration of certain value indications in a given area or event at a particular location in a graphic sample.

At act 174, sample indications are received, and associated in the database with graphic sample set and/or specific graphic sample elements.

Per acts 179-182, sample indication events can be associated with and indicate a number of different types of feedback or preferences from an audience member. At act 179, a set of graphic samples may be selected from among the presented graphic samples, for example, for inclusion in a subsequent survey where the new subset is presented without others in the current set. At act 180, a subset may be selected for inclusion in a later graphic sample presentation based on per audience member sample indications. At act 181, a subset may be selected for inclusion in a later graphic sample presentation based on a group of audience members sample indications. At act 182, the new set of graphic samples are presented for feedback separate from other graphic samples not selected by previously presented.

Sample indication events may be associated with an enter image sample or on a subimage level. For example, sample indications may be received and associated with various sample elements, such as individual objects of interest, a specific background, specific points or locations in an image, or a subregion of an image. This may be done, for example, by performing a drag and drop indication to a location within the image corresponding to one of the above-noted sample elements. A given indication may also be associated with an entire set of graphic samples or a subset of graphic samples. Audience members may create an association among plural image samples, and then apply sample indications to the entire new associated set of image samples.

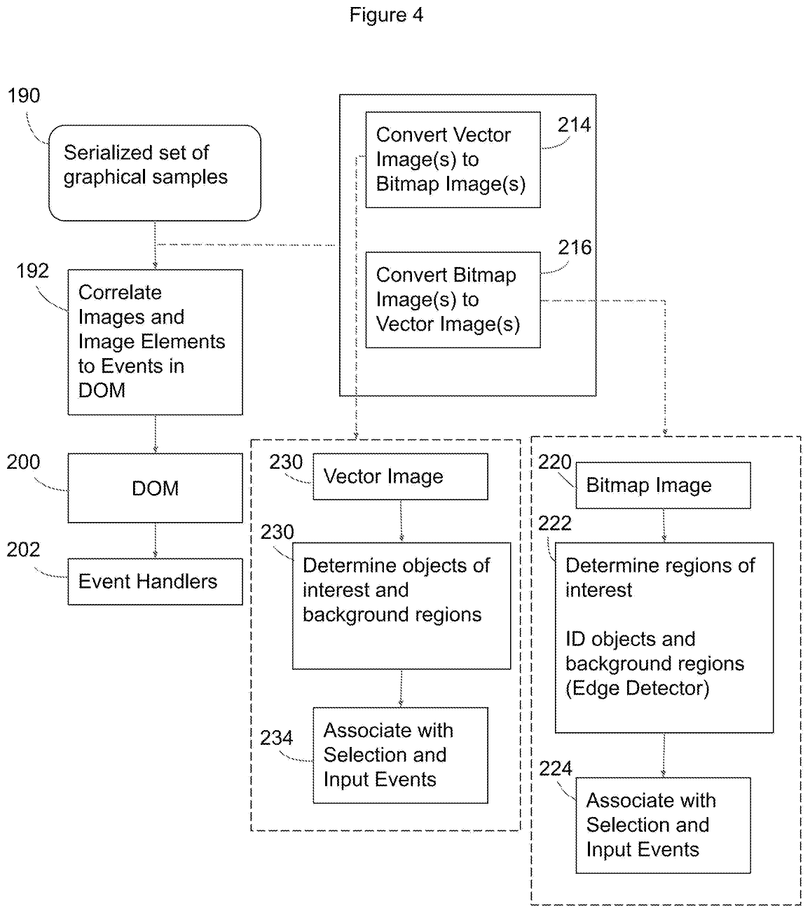

FIG. 4 shows a block diagram of systems and processes for interfacing with and processing image files, in one or more embodiments. A document object model 200 is provided, which interacts with one or more event handlers 202, and a browser 201 provided on or associated with a given audience member device 62. In the embodiments herein, these pieces may be implemented as one or more programs, and the program or programs are each embodied in one or more processing circuits. For example, document object model (DOM) 200 may reside on one or a combination of server 12 and each audience member device 12. Generally all or aspects of DOM 200 (e.g., in the form of trees or subtrees/shadow DOMs) are included into the rendering of a document which may be an HTML or an XML document. A DOM is a programming API for HTML, XML and other online documents. The DOM defines aspects (or all) of the logical structure of the document, and the way the document is accessed and manipulated. A DOM 200, in select embodiments herein, includes one or more tree structures with each node representing a part of the document.

Event handler (or handlers) 202 facilitates event-driven programming, and may, for example, use JAVA's addEventListener method. In the illustrated embodiment, DOM 200 includes events, and each document element contains a collection of events (e.g., click, mouseover, etc.) that can be triggered, e.g., by JavaScript code. Event handlers 202 are functions that are run in case of an event. The event may be a user action. An event is a signal that something has happened. DOM 200 may be configured such that each of its nodes generates such a signal, More specifically, by way of example, when an event such as a mouse clock at a given location X,Y representing coordinates of a window happens, browser 201 creates an event object, put details into that object, and passes it as an argument to the handler.

DOM 200 is configured to correlate graphic samples' images and other elements to events in the DOM. The illustrated graphic sample assessment may include an image processor 210 that, among other acts, map a vector image 212 into a serialized set of data for input to a display, e.g., on each audience member device. A vector-pixel image converter 214 may be provided for converting a vector image into a pixel image, and/or for converting portions (e.g., by region or by object) of a vector image into pixelized data to form pixel subimages in a hybrid vector/pixel image set. A pixel-vector image converter 216 may be provided for converting a pixel image into a vector image, and/or for converting portions (e.g., by region or by object) of a pixel image into vectors and associated data to form a vector image, vector images, or vector image portions.

When a given image is processed by vector-pixel converter 214, converter 214 may be configured or controllable by image processor 210 so that the entire given image is converted to a pixel image, or the given image may, after conversion, include a combination of a hybrid vector and pixel image set. When a given image is processed by pixel-vector converter 216, converter 216 may be configured or controllable by image processor 210 so that the entire given image is converted to a vector image, or the given image may, after conversion, include a combination of a hybrid vector and pixel image set.

Processes 219 and 229 are provided for processing different types of images, in order to be able to track and associate different portions of the sample images with audience member assessment or reaction activity, which are sometimes referred to herein as selection input events. In one embodiment, the graphic sample assessment system is configured to present separate graphic samples, arranged for example, in a grid or a sequence. This allows per-image feedback or assessment, whereby each image is associated with selection input events. In the embodiment shown in FIG. 4, processes 219 and 229 allow for sub-image feedback or assessment whereby individual objects of interest and background regions are separately identifiable and may be associated with selection input events.

Raster image process 219 processes a raster image 220. At act 222, a grid portion or regions of interest are selected from a given image. Then, within the selected grid or region of interest, objects of interest and background regions are delineated. This may be done with the aid of an edge detector. The objects of interest and background may be replaced with vector image data representations of the same elements, or delineation information may be provided to identify these portions without changing the raster/pixelized representations of the same elements. At act 224, the delineated and uniquely identified objects of interest and background regions are associated with selection and input events, e.g., by specifying corresponding ranges of image window coordinates for events in DOM 200.

Vector image process 229 processes a vector image 230. At act 232, objects of interest and background regions are determined and uniquely identified by reference to closed paths for objects of interest and discerned background regions outside of those closed paths. At act 234, the delineated and uniquely identified objects of interest and background regions are associated with selection and input events, e.g., by specifying corresponding ranges of image window coordinates for events in DOM 200.

The types of elements in the images that are considered objects of interest may be defined in accordance with the type of feedback sought by the designer. An analysis may be performed to determine the aspects of images for which audience members are providing input events, comments and other sorts of feedback. Some example image elements that could be defined as objects of interest (OOIs) include an item with a certain shape (corresponding to a closed path in a vector image), a particular color or range of colors that exists in a contiguous region, texturing of a particular type; a polygon mesh representing a shape of a polyhedral object (in the case of 3D computer graphics and solid modeling); and other design elements.

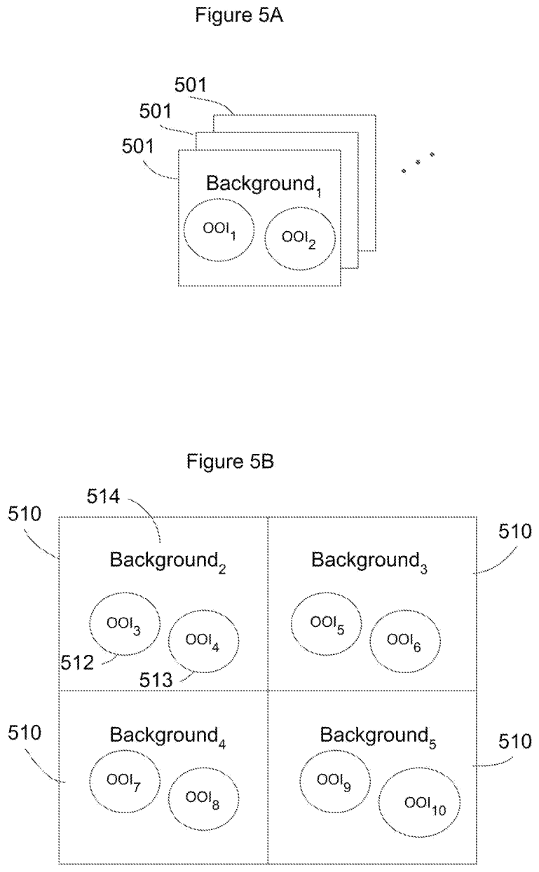

Per FIG. 5A, image samples may be presented in a sequence of displayed elements 501 displayed one after another at different moments of time. Per FIG. 5B, image samples may be presented in a grid of n×n (4×4 in the example shown) image samples. As shown in FIG. 5B, a given image sample may have a set of 00Is 512, 513 and one or more background regions 514. These display examples show images generally in vector form, i.e., with objects of interest and background. It is possible to represent each image sample in either or both of FIGS. 5A and 5B in the form of a pixel image. In addition, each image sample may be hybrid including both pixel and vector images with delineations of objects using vectors. In another embodiment, the collective concurrent display of the image samples shown in FIG. 5B may include a single bitmap (or hybrid) image representing all the samples in one image.

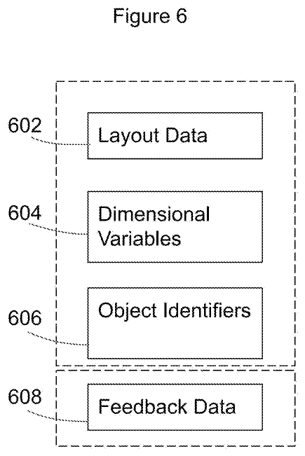

FIG. 6 is a schematic representation of graphic sample associated navigation and feedback data. The data includes layout data 602, dimensional variables 604, object identifiers 606, and feedback data 608 otherwise referred to herein as selection input events. The dimensional variables and object identifiers are associated with respective graphic samples. The dimensional variables may include an extent to which the given graphic sample spans first and second orthogonal directions (or first, second and third orthogonal directions). In one embodiment the dimensional variables represent values in pixels. In another embodiment, they represent distances in real world coordinates.

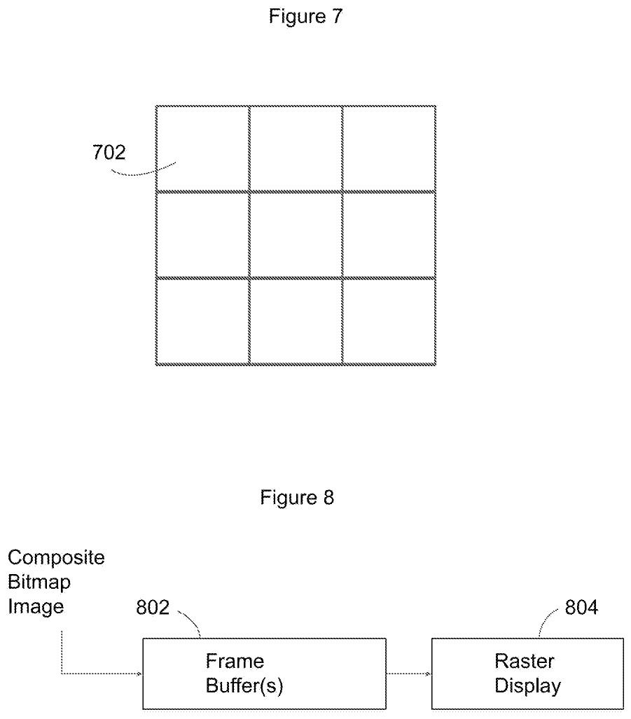

FIG. 7 is a schematic representation of a composite bitmap image, which includes an array or grid of bitmap images. FIG. 8 is a block diagram showing hardware for buffering and displaying a composite bitmap image. A serialized set of bitmap image data from the composite image is input into one or more frame buffers 802. Frame buffer or buffers 802 then cause the display of the composite image on raster display 804.

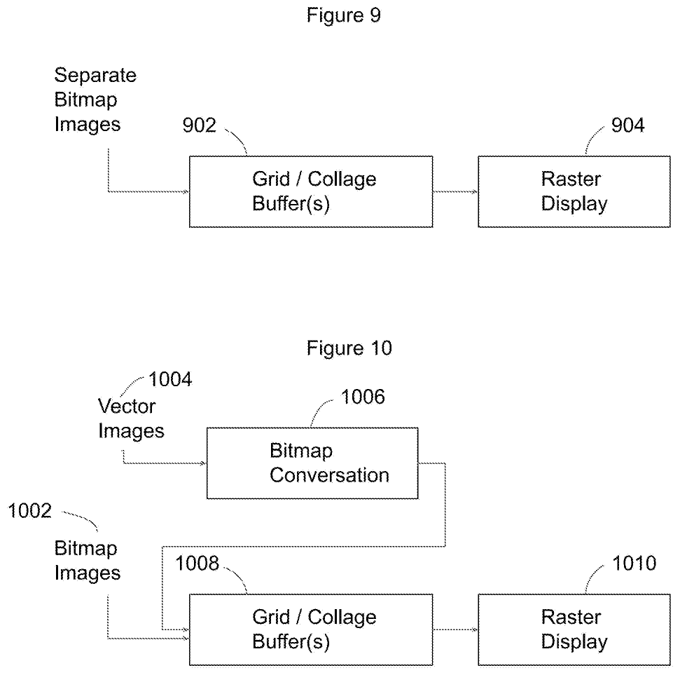

FIG. 9 is a block diagram showing hardware for buffering and displaying separate bitmap images. Separate bitmap images are received by a grid/collage buffer or set of buffers 902, the output of which is coupled to a raster display 904.

FIG. 10 is a block diagram showing hardware for processing, buffering, and displaying bitmap images 102 and vector images 104. Vector images are input into a bitmap conversion mechanism 106. Bitmap images 102 and converted bitmap versions of vector images 104 are then input to grid/collage buffer(s) 108 which cause display in the form of a grid or collage on raster display 110.

The graphic samples presented in the embodiments may be configured to present, on the audience member device's display, a set of graphic samples in a final presentation mode. When the graphic samples are presented in the form of a grid, per one embodiment, they may be in final presentation form in a two dimensional grid pattern, e.g., as shown in FIG. 5B with abutting rectangular samples. Alternatively, as shown in FIG. 5A, they may be presented at different times. For example, they may be displayed in succession.

The claims, as originally presented and as they may be amended, encompass variations, alternatives, modifications, improvements, equivalents, and substantial equivalents of the embodiments and teachings disclosed herein, including those that are presently unforeseen or unappreciated.

What is claimed is:

1. Apparatus comprising:
memory configured to hold data representing a set of graphic samples;
a question presenter configured to present, to an audience member's device, a question about the set of graphic samples;
a graphic sample presenter configured to present, on a display of the audience member's device, the set of graphic samples; and
a graphic input configured to receive sample indications from the audience member via the display, the received sample indications being associated with respective ones of the graphic samples.

2. The apparatus according to claim 1, wherein the memory is holding the data representing the sent of graphic samples including a given graphic sample comprising at least one of a two dimensional pixel image and a two dimensional vector image, wherein the memory is holding dimensional variables and element identifiers associated with the given graphic sample, the dimensional variables including an extent to which the given graphic sample spans at least first and second directions.

3. The apparatus according to claim 1, wherein the graphic samples in the presentation are in a two dimensional grid.

4. The apparatus according to claim 1, wherein the graphic samples in the presentation are presented at different times on a given audience member display.

5. The apparatus according to claim 1, wherein the graphic sample indications are tracked and associated with particular subsections of the given graphic sample.

6. The apparatus according to claim 1, further comprising an authentic entry checker that includes a normal range detector to detect when a characteristic of one or more select audience member actions are in a range deemed appropriate for an authentic entry.

7. The apparatus according to claim 6, wherein the audience member action is eye-tracking and the characteristic of the action, for a given sample indication about a given graphic sample, is an amount of time between the eyes of the audience member looking at the given graphic sample and the input of the graphic sample indication by the audience member.

8. The apparatus according to claim 7, wherein the audience member action detected includes the audience member's aggregated clicks associated with a given graphic sample, wherein when the aggregated clicks are below a threshold level of clicks per unit of time, then the action is deemed authentic.

9. The apparatus according to claim 1, further comprising a feedback refiner that refines the sample indications by associating them with specific subsections of a given graphic sample.

10. The apparatus according to claim 18, wherein the refiner is configured such that the refinement includes associating the sample indication with one or more particular objects embedded in a given graphic sample.

11. The apparatus according to claim 18, wherein the feedback refiner associates the graphic sample indications with specific portions of the given graphic sample by referring to layout data, dimensional variables, and/or object identifiers.

12. The apparatus according to claim 1, further comprising a bad lighting detector configured to determine if a sample indication corresponds to a portion of a graphic sample with bad lighting.

13. The apparatus according to claim 1, further comprising a low resolution detector configured to determine if a sample indication corresponds to a portion of a graphic sample with low resolution.

14. The apparatus according to claim 1, wherein the sample indications include positive and negative indications with specific positions in a graphic sample.

15. The apparatus according to claim 1, wherein the graphic input includes a user interface configuration configured to accept drag and drop inputs via interaction with a pointer and display of an audience member device, wherein the display presents the graphic samples to an audience member and wherein a given chosen positive or negative value is associated with a given location in a given graphic sample when the audience member drags the value to the given location on the display.

16. The apparatus according to claim 14, wherein the graphic sample indications include an indication meant to communicate a degree to which a given audience member favors or disfavors the given graphic sample or a portion of the given graphic sample.

17. The apparatus according to claim 14, wherein the graphic sample indications include a field configured to accept comments associated with a given location in the given graphic sample.

18. A method comprising:
providing memory to hold data representing a set of graphic samples;
presenting, to an audience member's device, a question about the set of graphic samples;
presenting, on a display of the audience member's device, the set of graphic samples; and
receiving on a graphic input sample indications from the audience member via the display, the received sample indications being associated with respective ones of the graphic samples.

19. Computer readable media encoded with data configured to cause when in operation with a computer:
providing memory to hold data representing a set of graphic samples;
presenting, to an audience member's device, a question about the set of graphic samples;
presenting, on a display of the audience member's device, the set of graphic samples; and
receiving on a graphic input sample indications from the audience member via the display, the received sample indications being associated with respective ones of the graphic samples.
